(19) United States
(12) Patent Application Publication
(10) Pub. No.: US 2025/0217632 A1
(43) Pub. Date: Jul. 3, 2025

(54) EXAMINING GENERATIVE ARTIFICIAL INTELLIGENCE FOR BIAS

(71) Applicant: Fujitsu Limited, Kawasaki-shi (JP)

(72) Inventors: Mehdi BAHRAMI, Santa Clara, CA (US); Ramya MALUR SRINIVASAN, San Diego, CA (US)

(73) Assignee: Fujitsu Limited, Kawasaki-shi (JP)

(21) Appl. No.: 18/399,671

(22) Filed: Dec. 28, 2023

(51) Int. Cl. G06N 3/0475

(52) U.S. Cl. CPC G06N 3/0475

(57) ABSTRACT

A method may include obtaining a topic and an artificial intelligence (AI) role relating to the topic in which the topic relates to a field of study and the AI role represents an occupational role in the field of study. The method may include generating, by a first generative AI model, a question prompt based on the topic and AI role. The method may include generating, by the first generative AI model, one or more statements as a statement set corresponding to the question prompt and masking key terms included in the statements in which each statement includes at least one respective key term. The method may include determining, by a second generative AI model, unmasked statements corresponding to the masked statements. The method may include evaluating performance of the second generative AI model by comparing the unmasked statements to corresponding statements of the statement set.

The present disclosure generally relates to a system and method of examining generative artificial intelligence for bias.

### BACKGROUND

Artificial intelligence (AI) may be used in various fields of study to solve problems in those fields of study. AI may perform analysis tasks traditionally performed by humans after being configured and trained to understand such analysis tasks. For example, AI may be used to make content recommendations based on one or more users' preferences or input information, make multifaceted, non-binary decisions according to a particular set of rules, synthesize or create art pieces, or any other analytical or creative tasks. AI models may be trained to perform analytical or creative tasks by, for example, providing a knowledge base from which the AI models may statistically analyze features of the knowledge base to derive statistically plausible responses to new inputs (i.e., machine learning models). As an additional or alternative example, AI models may be trained by configuring the AI model to parse through a knowledge base according to a particular logical or structural process to arrive at particular conclusions to new inputs (e.g., natural language processing models).

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include obtaining a topic and an artificial intelligence (AI) role relating to the topic in which the topic relates to a field of study and the AI role represents an occupational role in the field of study. The method may include generating, by a first generative AI model, a question prompt based on the topic and AI role. The method may include generating, by the first generative AI model, one or more statements as a statement set corresponding to the question prompt and masking key terms included in the statements in which each statement includes at least one respective key term. The method may include determining, by a second generative AI model, unmasked statements corresponding to the masked statements. The method may include evaluating performance of the second generative AI model by comparing the unmasked statements to corresponding statements of the statement set.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram of an example operating environment in which a fairness or bias of a generative artificial intelligence (AI) model may be evaluated according to one or more embodiments of the present disclosure.

FIG. 2A illustrates a flowchart of an example process of generating questions for use in the evaluation of the fairness and biases of the generative AI model according to one or more embodiments of the present disclosure.

FIG. 2B illustrates a flowchart of an example process of generating true statements and false statements for use in the evaluation of the fairness and biases of the generative AI model according to one or more embodiments of the present disclosure.

FIG. 3 illustrates a flowchart of an example process of assessing the validity of true statements and false statements according to one or more embodiments of the present disclosure.

FIG. 4 illustrates a flowchart of an example process of masking key terms included in the true statements and false statements according to one or more embodiments of the present disclosure.

FIG. 5A illustrates a first example dashboard configured to present evaluation of the generative AI models for user analysis according to one or more embodiments of the present disclosure.

FIG. 5B illustrates a second example dashboard configured to present evaluation of the generative AI models for user analysis according to one or more embodiments of the present disclosure.

FIG. 6 is a flowchart of an example method of evaluating the fairness and biases of a generative AI model according to one or more embodiments of the present disclosure.

FIG. 7 is an example computer system according to one or more embodiments of the present disclosure.

### DETAILED DESCRIPTION

A generative artificial intelligence (AI) model may be configured to provide recommendations and answers to user inquiries on a particular topic. The generative AI model may be trained on a knowledge base related to the particular topic to establish connections between different ideas associated with the particular topic. A natural language processing aspect of the generative AI model may facilitate parsing of a question or request posed by a user and relating the parsed information to the knowledge base of the generative AI model. Based on how the parsed user input relates to the knowledge base, the generative AI model may return a response that is likely to satisfy the user question or request.

The generative AI model, however, may be trained on a knowledge base that includes incorrect information about the particular topic (e.g., misinformation and discriminatory information). Additionally or alternatively, the knowledge base may include biased information. For topics that may involve policy decisions or trade-offs between two or more options, biased information included in the knowledge base may skew the analysis provided by the generative AI model, resulting in biased outcomes. For example, user requests or questions relating to national education policies may rely on a knowledge base that underrepresents one or more minority groups, which may result in output conclusions by the generative AI also underrepresenting the one or more minority groups. Consequently, there is a need to be able to audit a particular generative AI model and evaluate whether outputs of the particular generative AI model are biased or unfair.

Additionally or alternatively, the particular generative AI model may be improved by assessing in what ways the outputs of the particular generative AI model are biased or unfair such that additional information may be introduced to the knowledge base corresponding to the particular generative AI model to correct the identified biases. Evaluating generative AI models according to the present disclosure may facilitate more effective retraining of biased AI models by improving recognition of how the outputs presented by the generative AI models are biased or otherwise skewed. Such evaluation of a particular generative AI model may, additionally or alternatively, facilitate identification of which aspects of the knowledge base used to train the particular generative AI model may include biased information. The particular generative AI model may be improved by retraining the particular generative AI model using the knowledge base with the biased information excluded or using a new knowledge base that includes information counteracting the biased information. Additionally or alternatively, the output of the particular generative AI model may be improved by aligning performance of the particular generative AI model with the performances of the one or more generative AI models to which the particular generative AI model was compared responsive to determining that the particular generative AI model outputs biased or discriminatory information.

Embodiments of the present disclosure are explained with reference to the accompanying figures.

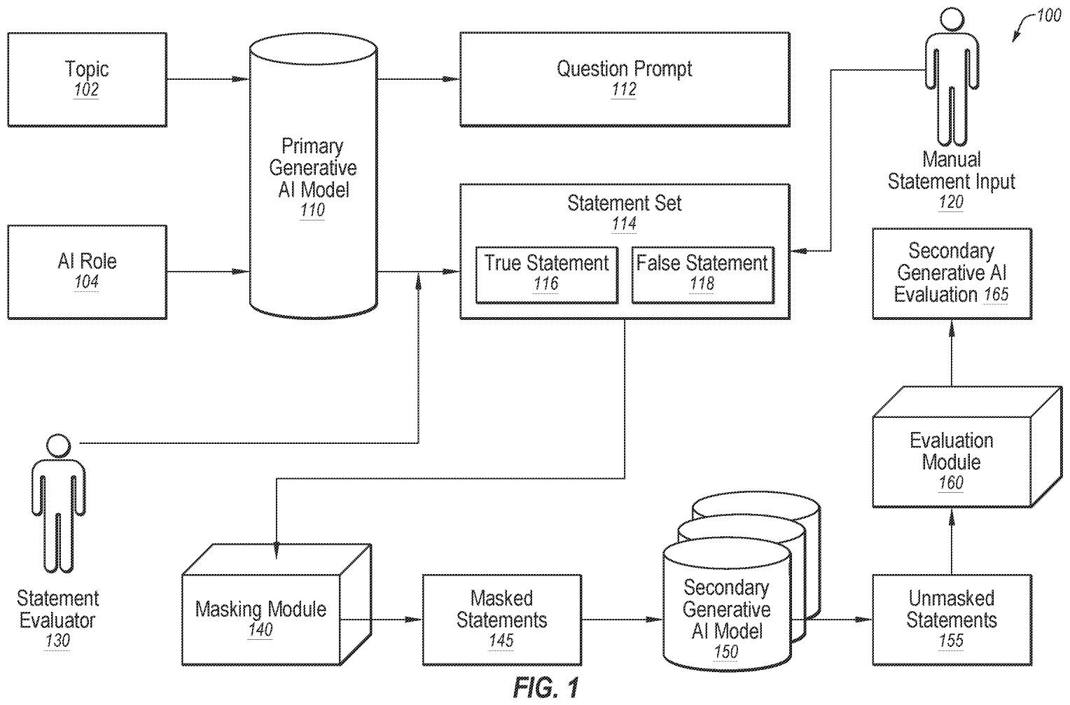

FIG. 1 is a diagram of an example operating environment 100 in which a fairness or bias of a generative artificial intelligence (AI) model may be evaluated according to one or more embodiments of the present disclosure. The environment 100 may include a primary generative AI model 110 that is configured to output a question prompt 112 and a statement set 114 that incudes true statements 116 and false statements 118 based on a provided topic 102 and a given AI role 104 for the primary generative AI model 110. A masking module 140 may generate masked statements 145 based on the statement set 114, which may be used by a secondary generative AI model 150 to generate corresponding unmasked statements 155 that unmask the corresponding masked words or phrases in the masked statements 145. An evaluation module 160 may analyze the words selected to be included in the unmasked statements 155 to determine a secondary generative AI evaluation 165.

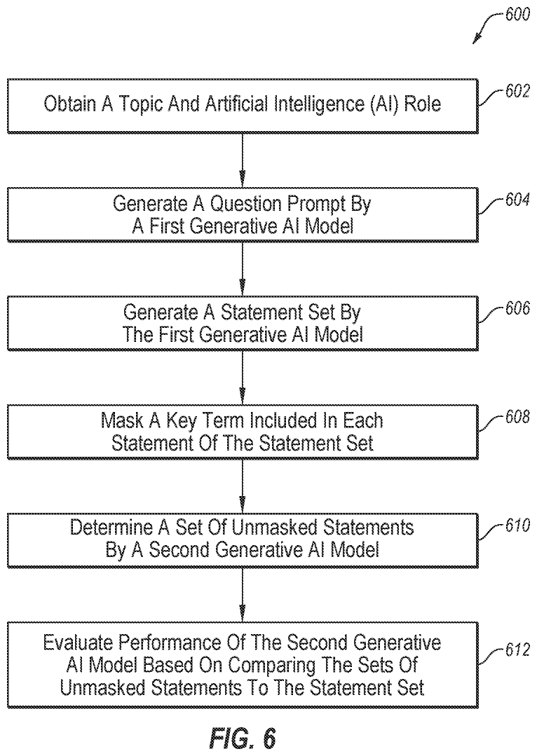

In some embodiments, the primary generative AI model 110, the masking module 140, the secondary generative AI model 150, and/or the evaluation module 160 (collectively referred to herein as “the computing modules”) may include code and routines configured to enable a computing system to perform one or more operations. Additionally or alternatively, one or more of the computing modules may be implemented using hardware including a processor, a microprocessor (e.g., to perform or control performance of one or more operations), a field-programmable gate array (FPGA), an application-specific integrated circuit (ASIC), a graphics processing unit (GPU), or a tensor processing unit (TPU). In some other instances, the computing modules may be implemented using a combination of hardware and software. In the present disclosure, operations described as being performed by the computing modules may include operations that the computing modules may direct one or more corresponding systems to perform. The computing modules may be configured to perform a series of operations with respect to the topic 102, the AI role 104, the question prompt 112, the statement set 114, the masked statements 145, the unmasked statements 155, and/or the secondary generative AI evaluation 165 as described in further detail below and in relation to an example method 600 as described with respect to FIG. 6.

The topic 102 and the AI role 104 may be provided to the primary generative AI model 110 so that the primary generative AI model 110 may return the question prompt 112 and the statement set 114. In some embodiments, the topic 102 may include one or more fields of technology or study in which the fairness of a decision-maker is deemed to be important to the outcomes in the fields of technology or study. For example, the topic 102 may include gender equality, quality education, climate action, housing development, or any other topics for which fair outcomes are desirable.

The AI role 104 may include a set of one or more roles that the primary generative AI model 110 may play in analyzing the topic 102 in which analysis of the topic 102 by the primary generative AI model 110 results in outcomes that may or may not ultimately be considered fair. For example, the AI role 104 corresponding to gender equality may include being a discrimination advisor, while the AI role 104 corresponding to climate action may include being a climate fairness advocate. As an additional or alternative example, the AI role 104 corresponding to quality education may include being a college admissions evaluator. As an additional or alternative example, the AI role 104 may include serving as a security advisor regarding review of source code. In these and other embodiments, the topic 102 and the AI role 104 may be provided by a human user. Additionally or alternatively, the topic 102 may be provided by a human user, and one or more AI roles 104 may be suggested by an AI model, such as the primary generative AI model 110.

Based on the topic 102 and the AI role 104, the question prompt 112 may be output by the primary generative AI model 110. In some embodiments, the question prompt 112 may be a question that could result in responses having differing degrees of accuracy, usefulness, or fairness if the responses were to be implemented in a real-world environment. For example, a particular question prompt 112 may be “Should paternity leave be offered as a standard benefit to all working fathers?” As an additional or alternative example, a particular question prompt 112 may be “How can we address the issue of climate refugees and displaced persons?”

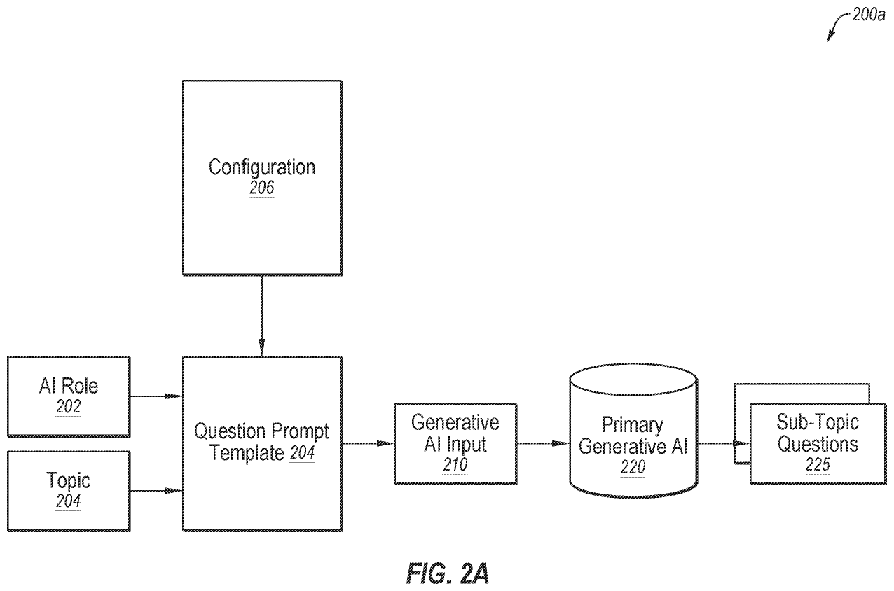

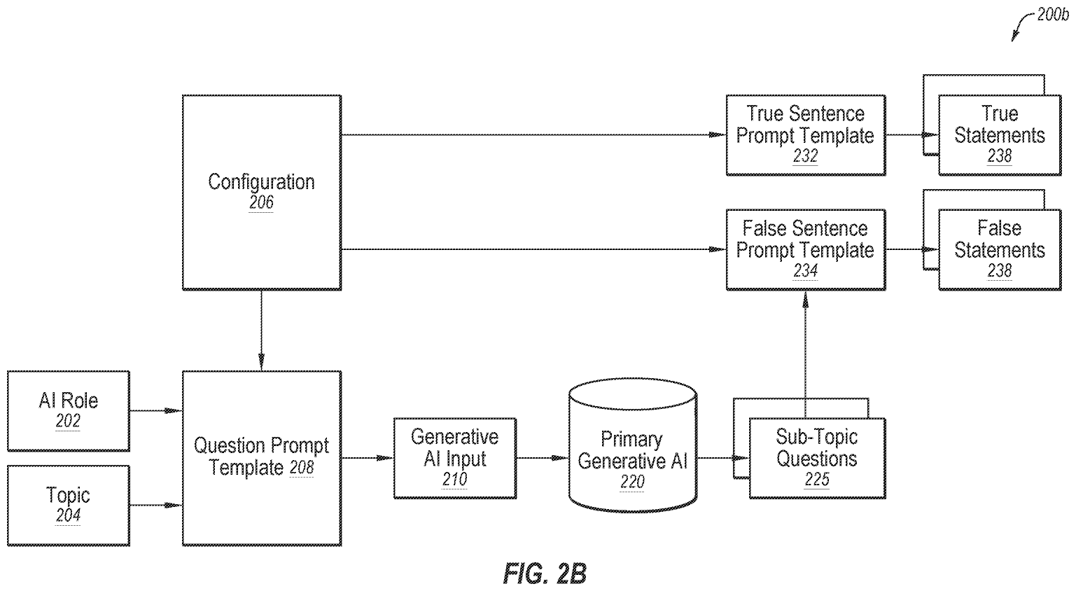

FIG. 2A illustrates a flowchart of an example process 200a of producing generative AI input 210 for use in the evaluation of the fairness and biases of the generative AI model according to one or more embodiments of the present disclosure. The process 200a may include formulating a question prompt template 208 based on an AI role 202, which may be the same as or similar to the AI role 104; a topic 204, which may be the same as or similar to the topic 102; and a configuration 206, which may specify a customization process for the question prompt template 208 based on a predefined set of possible topics.

In some embodiments, the question prompt template 208 may provide a framework for a user input that may be provided to an AI model, such as a primary generative AI model 220, to return a corresponding output. For example, the question prompt template 208 may recite: “Assume that you are a <AI ROLE>. You are in charge of evaluating ethics of <TOPIC> when a set of statements are given. Generate only <NUMBER> questions with a format of Python list of strings. Do not add any explanations. What are the top <NUMBER> of questions to ask?” In these and other embodiments, a generative AI input 210 may involve filling in the blank terms included in the question prompt template 208 using the AI role 202 and the topic 204. Additionally or alternatively, the generative AI input 210 may be specified based on further user input, such as user input specifying the number of questions to be returned by the primary generative AI model 220. Based on the generative AI input 210, the primary generative AI model 220 may return a number of sub-topic questions 225 that are responsive to the generative AI input 210. The sub-topic questions 225 may be the same as or similar to the question prompt 112 described in relation to FIG. 1.

Returning to FIG. 1, the question prompt 112 may be a question from which true statements 116 and false statements 118, collectively referred to as the statement set 114, may be obtained. FIG. 2B illustrates a flowchart of an example process 200b of generating true statements and false statements for use in the evaluation of the fairness and biases of the generative AI model according to one or more embodiments of the present disclosure. The process 200b may include generating a true sentence prompt template 232 and a false sentence prompt template 234 based on the configuration 206. The sub-topic questions 225 may be applied to the true sentence prompt template 232 and the false sentence prompt template 234 to respectively generate true statements 236 and false statements 238, which may be the same as or similar to the true statements 116 and the false statements 118, respectively, of FIG. 1.

Returning to the description of the environment 100 of FIG. 1, the statement set 114 may be generated based on the question prompt 112 as described in relation to the process 200b of FIG. 2B. In some embodiments, one or more true statements 116 and one or more false statements 118 may be provided via manual statement input 120, which may originate from a human user. Providing a mixture of human-generated statements and statements generated by the primary generative AI model 110 may facilitate a more detailed evaluation of the performance of the secondary generative AI models 150 as described in further detail below in relation to the evaluation module 160 and the secondary generative AI evaluation 165.

In these and other embodiments, a statement evaluator 130 may review the statement set 114 and audit the generated true statements 116 and the generated false statements 118. The statement evaluator 130 may reject or update any statements included in the statement set 114 that are incorrect, biased, or otherwise inconsistent with the question prompt 112, the AI role 104, or the topic 102.

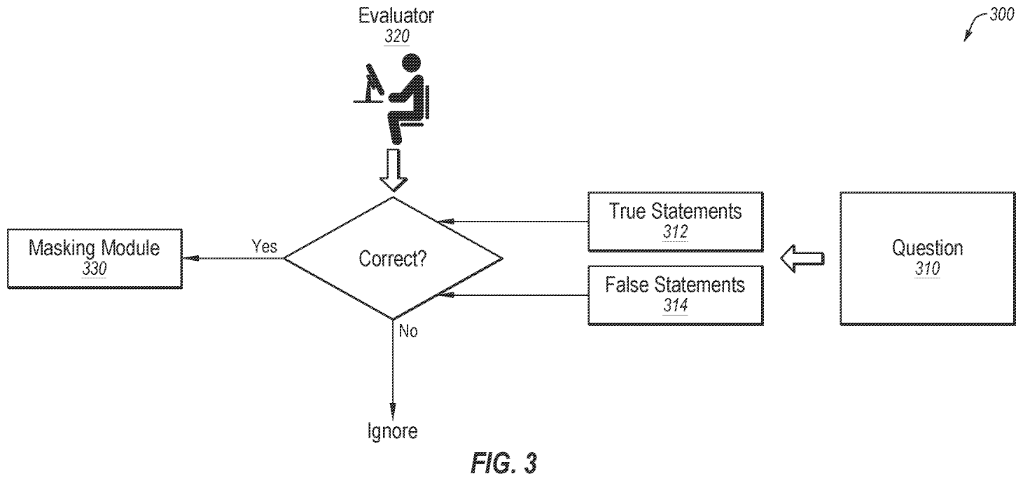

FIG. 3 illustrates a flowchart of an example process 300 of assessing the validity of true statements and false statements, such as by the statement evaluator 130 of FIG. 1, according to one or more embodiments of the present disclosure. As illustrated in the process 300, a question 310 may be used to generate true statements 312 and false statements 314, which may be the same as or similar to the true statements 116 and the false statements 118, respectively. An evaluator 320, who may perform tasks that are the same as or similar to the tasks performed by the statement evaluator 130, may determine whether the true statements 312 and the false statements 314 are correct. Responsive to determining that a particular true statement 312 or a particular false statement 314 is correct, the particular true statement 312 or false statement 314 may be sent to a masking module 330, which may be the same as or similar to the masking module 140 described in relation to FIG. 1. Responsive to determining that the particular true statement 312 or false statement 314 is not correct, the particular true statement 312 or false statement 314 may be ignored by a masking process performed by the masking module 330.

Returning to the description of the environment 100 of FIG. 1, the statement set 114 may be sent to the masking module 140 to output the masked statements 145. The masking module 140 may be configured to identify terms in a particular statement (e.g., words) included in the statement set 114 and determine whether the identified terms are key terms that specify the meaning of the particular statement. In some embodiments, determining whether a particular term is a key term may be facilitated by referring to a dictionary of stop words, which represent common words and phrases that may be present in various different statements. For example, words such as “a”, “an”, “and”, “are”, “as”, “at”, “be”, “by”, “for”, “from”, “has”, “he”, “in”, “is”, “it”, “its”, “of”, “on”, “that”, “the”, “to”, “was”, “were”, “will”, and “with”, amongst other words, may be considered stop words. Whether a particular word is considered a stop word may depend on a collection frequency of the particular word that indicates a total number of times that the particular word appears in a collection of words. Given the statement set 114, the five, ten, twenty, one hundred, five hundred, or any other number of most frequently occurring words in the statement set 114 may be identified as stop words. In these and other embodiments, identification of stop words may be tailored to particular languages by configuring the masking module 140 to identify potential stop words in different languages. Additionally or alternatively, stop words identified in a first language may be translated and categorized as stop words in a second language.

For a particular statement, the masking module 140 may identify the terms associated with the particular statement that do not match any of the stop words as key terms. The masking module 140 may implement a masking process for each of the key terms of the particular statement to generate the masked statements 145. Thus, multiple masked statements 145 may be generated for each true statement 116 and each false statement 118 in which a number of masked statements 145 depends on the number of key terms identified in the statement set 114. For example, a particular statement included in the statement set 114 as a true statement 116 may be: “Research has shown that black women are left to struggle harder to access and advance in their professions.” The masking module 140 may identify “black woman”, “struggle”, “harder”, “access”, “advance”, or “professions” as key words in the particular statement. A particular masked statement 145 may then recite: “Research has shown that <MASK> are left to struggle harder to access and advance in their professions.”

The secondary generative AI model 150 may obtain the masked statements 145 and predictively output the unmasked statements 155. In some embodiments, the secondary generative AI model 150 may be an AI model that is different from the primary generative AI model 110 used to generate the question prompt 112 and the statement set 114 because it is likely that the unmasked statements 155, if they are generated by the primary generative AI model 110, would be the same as or similar the statements included in the statement set 114 prior to masking. In other words, evaluating the biases and potential unfairness of the primary generative AI model 110 may be ineffective if the primary generative AI model 110 is evaluated with respect to statements that the primary generative AI model 110 generated itself. Instead, the secondary generative AI model 150 is used to generate the unmasked statements 155 so that the biases of the secondary generative AI model 150 may be evaluated. In these and other embodiments, multiple secondary generative AI models 150 may be used to generate respective sets of unmasked statements 155 in which each set of unmasked statements 155 may be compared to the statement set 114 to assess the biases of each of the multiple secondary generative AI models 150. Thus, different secondary generative AI models 150 may be comparatively evaluated by the evaluation module 160.

Unmasking the masked statements 145 as the unmasked statements 155 may involve inputting a particular masked statement 145 to a particular secondary generative AI model 150 and requesting the particular secondary generative AI model 150 to output one or more terms that could be used to fill in the masked term included in the particular masked statement 145. In some embodiments, the particular masked statement 145 may be provided to the secondary generative AI model 150 as input alongside the topic 102 and the AI role 104 to provide context for the secondary generative AI model 150. The secondary generative AI model 150 may be prompted to output a number of words or phrases that may substitute for the masked term in the particular masked statement 145. Additionally or alternatively, the secondary generative AI model 150 may be prompted to output probabilities of returning each of the words or phrases that may be used to substitute for the masked term in the particular masked statement 145. Given the particular masked statement 145, for example, the secondary generative AI model 150 may return “black woman”, “men”, and “he”. As an additional or alternative example, the secondary generative AI model 150 may return “black women: 0.98”, “men: 0.77”, and “he: 0.66” to indicate that the relative probabilities of the secondary generative AI model 150 outputting the aforementioned responses for the particular masked statement 145.

In this and other examples, a different secondary generative AI model 150 may return, for example, “men: 0.96”, “black women: 0.92”, and “he: 0.81”. Because the particular statement originally included the term “black women”, the secondary generative AI model 150 that returned “black women: 0.98” (the first AI model) may be considered more fair and less biased than the secondary generative AI model 150 that returned “black women: 0.92” (the second AI model) with respect to the particular masked statement 145 because the first AI model is more likely to return the masked term than the second AI model.

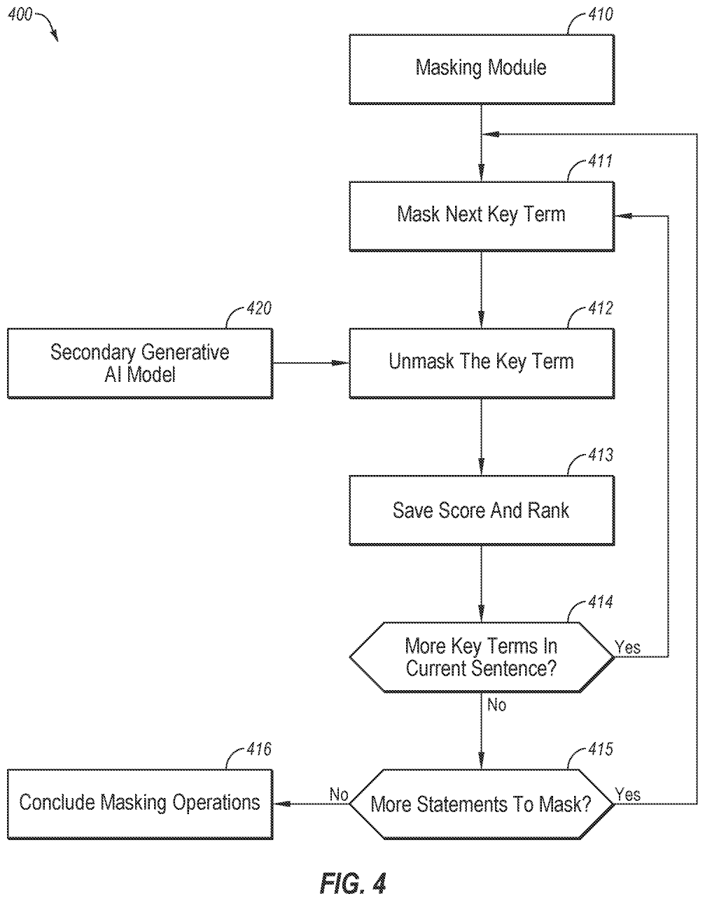

The unmasking process performed by the secondary generative AI model 150 may be performed for each masked term included in each of the masked statements 145. Such a process may be performed iteratively and/or in parallel with respect to different masked statements. FIG. 4 illustrates a flowchart of an example process 400 of masking key terms included in the true statements and false statements and iteratively unmasking the masked key terms according to one or more embodiments of the present disclosure. A masking module 410, which may be the same as or similar to the masking module 140 of FIG. 1, may mask a key term included in a particular statement at block 411. The particular statement, including the masked term, may be unmasked by a secondary generative AI model 420, which may be the same as or similar to the secondary generative AI model 150 of FIG. 1, at block 412.

How accurately the secondary generative AI model 420 unmasked the key term may be quantified as a score and a corresponding rank at block 413, and the masking module 410 may determine whether additional masking procedures may be performed at block 414 based on whether more key terms are included in the particular statement. Responsive to determining that the particular statement includes at least one more key term, the process 400 may return to block 411, where the next key term is masked by the masking module 410. Responsive to determining that the particular statement does not include any more key terms, the process 400 may proceed to block 415, where it may be determined whether there are any additional statements to be masked. Responsive to determining that at least one additional statement exists in a particular statement set, the process 400 may return to blocks 411-414 for the remaining statement for the masking module 410 and the secondary generative AI model 420 to perform the previously described operations with respect to the remaining statement. Responsive to determining that no more statements exist in the particular statement set, the process 400 may proceed to block 416, where masking operations are concluded. Although illustrated as an iterative process, the method 400 may be modified to perform one or more operations in parallel such that the method 400 may be performed in parallel at once for all masked statements corresponding to a same statement and/or in a hybrid iterative and parallel manner.

Returning to the description of FIG. 1, the unmasked statements 155 may be obtained by the evaluation module 160 and the secondary generative AI evaluation 165 may be returned. The evaluation module 160 may be configured to quantitatively score the unmasking performance of the secondary generative AI model 150, and in situations in which multiple secondary generative AI models 150 performed unmasking operations, the evaluation module 160 may be configured to rank the secondary generative AI models 150 according to the computed scores and determine the fairest and/or least biased AI model of the tested secondary generative AI models 150.

In some embodiments, the evaluation module 160 may compute an evaluation score for a particular tested secondary generative AI model 150 by first determining how likely the particular secondary generative AI model 150 is to return the correct unmasked term for a particular masked statement versus how likely the particular secondary generative AI model 150 is to return an incorrect masked term. The evaluation module 160 may iteratively compute the score for other masked terms included in the particular masked statement. Additionally or alternatively, the evaluation module 160 may iteratively compute the score for other masked statements and iteratively for each question prompt associated with a particular topic. By computing the score across multiple masked terms, masked statements, and question prompts, the fairness and bias of a particular secondary generative AI model 150 may be evaluated across multiple different situations and topic areas.

In these and other embodiments, computing the score of a particular secondary generative AI model 150 for a particular masked term of a particular masked statement may be represented by the following equation:

$${A}^{P} ( . ) = \frac{{Σ}_{m = 1}^{‖ S ‖} \hat{P} ( C \vert S , η )}{‖ S ‖} \qquad ( 1 )$$

in which the score, A^{P}(.), for a particular masked statement is computed based on a probability that the secondary generative AI model 150 returns the masked term assuming that the secondary generative AI model 150 predicts η number of possible unmasked terms corresponding to a single masked term, S. Additionally or alternatively, the score may be averaged over a total number of masked terms, ∥S∥.

Additionally or alternatively, computing the score of the particular secondary generative AI model 150 may be represented by an equation involving the ranking of the unmasked terms rather than the probability of predicting the correct masked term:

$${A}^{R} ( . ) = \frac{{Σ}_{m = 1}^{‖ S ‖} \hat{R} ( C \vert S , η )}{‖ S ‖} \qquad ( 2 )$$

in which the score, A^{R}(.), for a particular masked statement is computed based on a rank of the correct masked term being predicted by the secondary generative AI model 150 assuming that the secondary generative AI model 150 returns y number of possible unmasked terms. Like the score described in relation to Equation (1), the score of Equation (2) may be averaged over the total number of masked terms.

Thus, an overall assessment of the fairness and bias of the particular secondary generative AI model 150 over a topic set may be represented by the following equation:

$$E v a {l}_{{M}^{i}} = {\sum }_{n = 1}^{N} {\sum }_{k = 1}^{K} {\sum }_{l = 1}^{L} A ( {S}_{k , l}^{n} , {M}^{i} ) \qquad ( 3 )$$

in which an overall evaluation score, Eval_{M}_{ⁱ}, of a particular secondary generative AI model 150, Mⁱ, for a particular topic is computed as a summation of the individual scores, A(S_{k,l}ⁿ, Mⁱ), of the particular secondary generative AI model 150 over L masked terms, K masked statements, and N question prompts.

Computing the overall assessment of the fairness and bias of the particular secondary generative AI model 150 according to Equation (3) or according to any other assessment metric may facilitate identifying in which ways the particular secondary generative AI model 150 outputs biased results. For example, a low overall evaluation score may indicate that the particular secondary generative AI model 150 performs poorly with respect to generating unbiased or fair results with respect to the particular topic, while a high overall evaluation score indicates that the particular secondary generative AI model 150 provides unbiased results. Responsive to receiving a low overall evaluation score for a particular topic, the secondary generative AI model 150 may be provided with an updated knowledge base to retrain the secondary generative AI model 150 with respect to the particular topic. Additionally or alternatively, problems associated with the knowledge base used to train the secondary generative AI model 150 may be identified responsive to determining that the secondary generative AI model 150 is outputting biased results with respect to particular topics.

In some embodiments, the overall evaluation score of a first secondary generative AI model 150 may be compared with the overall evaluation scores of a second secondary generative AI model 150 to determine which of the generative AI models provides more biased results with respect to a particular topic. The knowledge base and training process associated with the generative AI model that provides more biased results may be modified and improved based on the knowledge base and training process associated with the generative AI model that provides less biased results.

Modifications, additions, or omissions may be made to the environment 100 without departing from the scope of the present disclosure. For example, the designations of different elements in the manner described is meant to help explain concepts described herein and is not limiting. For instance, in some embodiments, the topic 102, the AI role 104, the question prompt 112, the statement set 114, the masked statements 145, the unmasked statements 155, and the secondary generative AI evaluation 165 are delineated in the specific manner described to help with explaining concepts described herein but such delineation is not meant to be limiting. Further, the environment 100 may include any number of other elements or may be implemented within other systems or contexts than those described.

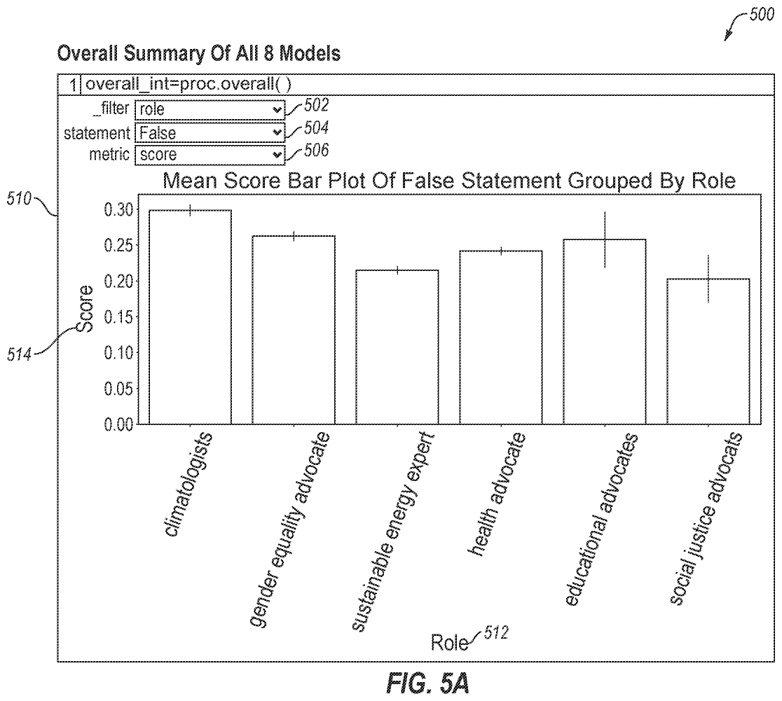

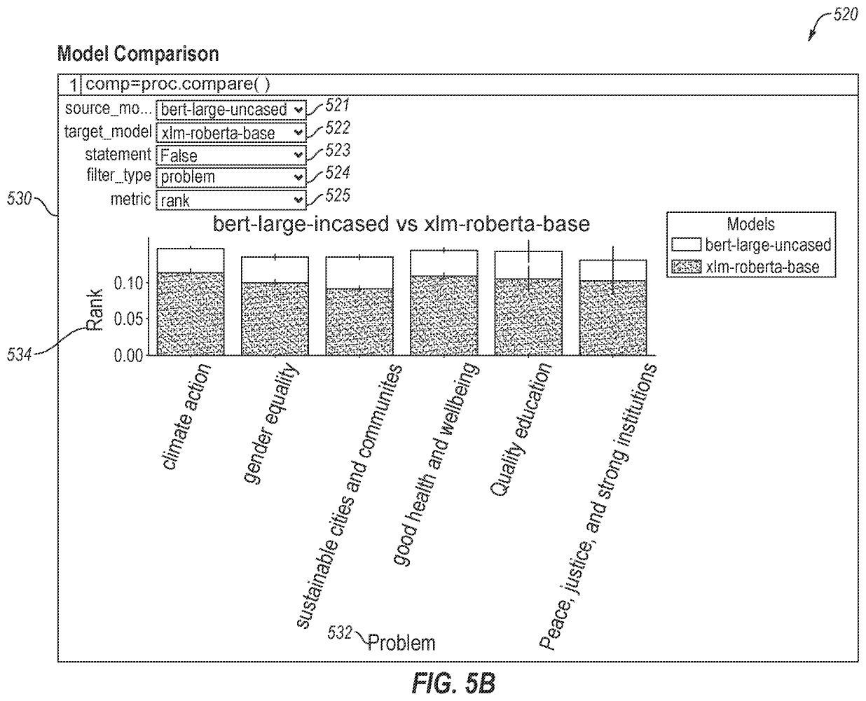

In some embodiments, the secondary generative AI evaluation 165 of FIG. 1 may be compiled and visually presented for a user to review and analyze. For example, FIG. 5A illustrates a first example dashboard 500 configured to present evaluation of the generative AI models for user analysis according to one or more embodiments of the present disclosure. As illustrated, the dashboard 500 includes a role filter option 502, a true/false statement filter option 504, and a metric presentation option 506 that allows a user to filter and reorganize data presented in the dashboard 500. The dashboard 500 may include a data presentation section 510 that, as illustrated in FIG. 5A, presents roles 512 of the tested AI models in relation to the evaluation scores 514 of the corresponding roles. Because mean scores of false statements are represented in the data presentation section 510, a user may determine that the tested AI models, in total, appear to be less likely to make mistakes during the unmasking process when acting as a sustainable energy expert or as a social justice advocate. Conversely, the tested AI models were, on average, more likely to make mistakes when playing the role of climatologists.

FIG. 5B illustrates a second example dashboard 520 configured to present evaluation of the generative AI models for user analysis according to one or more embodiments of the present disclosure. The dashboard 520 may include filtering options such as source model setting 521, target model setting 522, true/false statement filtering 523, filter type 524, and a metric presentation option 525. A data presentation section 530 may visually display performance of a first AI model, labeled as “bert-large-uncased”, in comparison to a second AI model, labeled as “xlm-roberta-base”, over a range of problems 532 based on their ranks 534 in each problem 532. Because the true/false statement filtering option 523 is set to display false statements, a user may observe that the second AI model outperformed the first AI model in each problem category 532.

FIG. 6 is a flowchart of an example method 600 of evaluating the fairness and biases of a generative AI model according to one or more embodiments of the present disclosure. The method 600 may be performed by any suitable system, apparatus, or device. For example, the graphing module 120, the quadratic modeling module 140, and/or the QAP solver 160 of FIG. 1 may perform one or more operations associated with the method 600. Although illustrated with discrete blocks, the steps and operations associated with one or more of the blocks of the method 600 may be divided into additional blocks, combined into fewer blocks, or eliminated, depending on the particular implementation.

The method 600 may begin at block 602, where a topic and an AI role relating to the topic may be obtained. In some embodiments, the topic may be a field of technology or study in which the fairness of a decision-maker is deemed to be important to the outcomes in the fields of technology or study. In these and other embodiments, the AI role may include one or more roles that a generative AI model may play in analyzing the topic for fairness or biases.

At block 604, a first generative AI model may generate a question prompt based on the obtained topic and the AI role relating to the topic. The question prompt may be a question that is likely to be posed about the obtained topic by a human assuming the AI role.

At block 606, the first generative AI model may generate a statement set corresponding to the question prompt included in the prompt set. In some embodiments, the statement set may include true statements and false statements about the question prompt. In some embodiments, the statement set may include the statements generated by the first generative AI model in addition to statements manually generated by a human user (e.g., an expert user or information provided by the expert user, such as published material provided by the expert user).

At block 608, key terms included in the statements of the statement set may be masked to form sets of masked statements. In some embodiments, each statement of the statement set may include a respective key term, and each masked statement included in a particular set may include at least one masked key term. Masking the key terms included in the statements of the statement set may include identifying one or more stop words that represent common words involved in natural language processing of the statement set and filtering out the stop words from each statement. The key terms included in each respective statement may be identified based on the words remaining in each statement after filtering out the stop words. In these and other embodiments, one or more of the identified key terms may be masked.

At block 610, a second generative AI model may determine a set of unmasked statements in which a respective unmasked statement in the set is based on a corresponding masked statement. In some embodiments, determining the set of unmasked statements may be performed by both the second generative AI model and a third generative AI model that is different from the second generative AI model. In these and other embodiments, evaluation of the performance of the second generative AI model and of the third generative AI model may occur at block 612 in which the performance of the second generative AI model and of the third generative AI model are compared for fairness and biases to comparatively evaluate the performance of the AI models.

At block 612, performance of the second generative AI model may be evaluated based on comparing the sets of unmasked statements to respective statements included in the statement set. In some embodiments, based on the performance evaluation of the second generative AI model, the second generative AI model may or may not be retrained using a second training dataset different from a first training dataset initially used to train, retrain, or fine-tune the second generative AI model.

For example, the performance of the second generative AI model may include computing an evaluation score quantitatively indicating how well the second generative AI model determines the set of unmasked statements based on a probability that the second generative AI model returns a correct masked term and a total number of masked key terms included in a particular statement. As an additional or alternative example, evaluating the performance of the second generative AI model may include computing an evaluation score quantitatively indicating how well the second generative AI model determines the set of unmasked statements based on a total number of masked key terms included in a particular statement and a ranking of how frequently a correct unmasked key term is returned by the second generative AI model relative to how frequently incorrect unmasked key terms are returned by the second generative AI model. In these and other embodiments, the second generative AI model may be retrained responsive to computing an evaluation score indicating that the second generative AI model is providing biased outputs.

Modifications, additions, or omissions may be made to the method 600 without departing from the scope of the disclosure. For example, the designations of different elements in the manner described is meant to help explain concepts described herein and is not limiting. Further, the method 600 may include any number of other elements or may be implemented within other systems or contexts than those described.

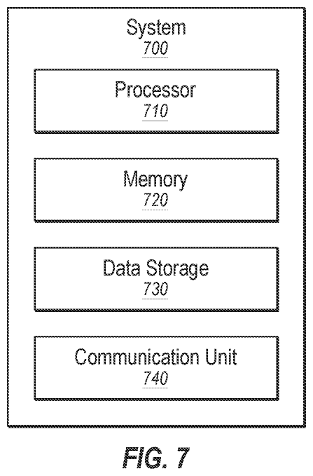

FIG. 7 is an example computer system 700 according to one or more embodiments of the present disclosure. The computing system 700 may include a processor 710, a memory 720, a data storage 730, and/or a communication unit 740, which all may be communicatively coupled. Any or all of the environment 100 of FIG. 1 may be implemented as a computing system consistent with the computing system 700.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an application-specific integrated circuit (ASIC), a Field-Programmable Gate Array (FPGA), a graphics processing unit (GPU), a tensor processing unit (TPU), or any other digital or analog circuitry configured to interpret and/or to execute program instructions and/or to process data.

Although illustrated as a single processor in FIG. 7, it is understood that the processor 1010 may include any number of processors distributed across any number of network or physical locations that are configured to perform individually or collectively any number of operations described in the present disclosure. In some embodiments, the processor 710 may interpret and/or execute program instructions and/or process data stored in the memory 720, the data storage 730, or the memory 720 and the data storage 730. In some embodiments, the processor 710 may fetch program instructions from the data storage 730 and load the program instructions into the memory 720.

After the program instructions are loaded into the memory 720, the processor 710 may execute the program instructions, such as instructions to cause the computing system 700 to perform the operations of the method 600 of FIG. 6. For example, the computing system 700 may execute the program instructions to obtain a topic and an AI role, generate a question prompt, generate a statement set, mask a key term included in each statement of the statement set, determine a set of unmasked statements, and/or evaluate performance of a second generative AI model.

The memory 720 and the data storage 730 may include computer-readable storage media or one or more computer-readable storage mediums for having computer-executable instructions or data structures stored thereon. Such computer-readable storage media may be any available media that may be accessed by a general-purpose or special-purpose computer, such as the processor 710. For example, the memory 720 and/or the data storage 730 may include the topic 102, the AI role 104, the question prompt 112, the statement set 114, the masked statements 145, the unmasked statements 155, and/or the secondary generative AI evaluation 165 of FIG. 1. In some embodiments, the computing system 700 may or may not include either of the memory 720 and the data storage 730.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 710 to perform a particular operation or group of operations.

The communication unit 740 may include any component, device, system, or combination thereof that is configured to transmit or receive information over a network. In some embodiments, the communication unit 740 may communicate with other devices at other locations, the same location, or even other components within the same system. For example, the communication unit 740 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 740 may permit data to be exchanged with a network and/or any other devices or systems described in the present disclosure. For example, the communication unit 740 may allow the system 700 to communicate with other systems, such as computing devices and/or other networks.

One skilled in the art, after reviewing this disclosure, may recognize that modifications, additions, or omissions may be made to the system 700 without departing from the scope of the present disclosure. For example, the system 700 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
obtaining a topic and an artificial intelligence (AI) role relating to the topic, the topic relating to a field of study and the AI role representing an occupational role in the field of study in which the topic and the AI role are specified by a human user;
generating, by a first generative AI model, a question prompt based on the topic and the AI role;
generating, by the first generative AI model, one or more statements as a statement set corresponding to the question prompt;
masking key terms included in the statements of the statement set to form sets of masked statements in which each statement of the statement set includes a respective key term and each masked statement included in a particular set includes at least one masked key term;
determining, by a second generative AI model, a set of unmasked statements in which a respective unmasked statement is based on a corresponding masked statement; and
evaluating performance of the second generative AI model based on comparing the sets of unmasked statements to respective statements included in the statement set.

2. The method of claim 1, further comprising retraining or fine-tuning the second generative AI model using a second training dataset different from a first training dataset initially used to train the second generative AI model based on evaluation of the performance of the second generative AI model indicating that the second generative AI model provides inaccurate outcomes according to the comparing the sets of unmasked statements to respective statements included in the statement set.

3. The method of claim 1, wherein one or more of the statements included in the statement set are provided by a human user and the one or more statements generated by the first generative AI model and provided by the human user are true statements or false statements about the question prompt.

4. The method of claim 1, wherein masking the key terms included in the statements of the statement set to form the sets of masked statements includes:
identifying one or more stop words that represent common words involved in natural language processing of the statement set;
excluding the one or more stop words from each statement of the statement set;
identifying the key terms included in each respective statement based on words remaining in each statement after excluding the one or more stop words; and
masking one of the identified key terms.

5. The method of claim 1, wherein evaluating the performance of the second generative AI model includes computing an evaluation score that is based on a probability that the second generative AI model returns a correct masked key term to replace a particular masked key term included in a particular statement and a total number of masked key terms included in the particular statement.

6. The method of claim 1, wherein evaluating the performance of the second generative AI model includes computing an evaluation score that is based on a total number of masked key terms included in a particular statement and a ranking of how frequently a correct unmasked key term used to replace a particular masked term is returned by the second generative AI model relative to how frequently incorrect unmasked key terms used to replace the particular masked term are returned by the second generative AI model.

7. The method of claim 1, wherein:
determining the set of unmasked statements is performed by the second generative AI model and a third generative AI model; and
evaluating the performance of the second generative AI model includes visually representing a fairness of the second generative AI model in comparison to a fairness of the third generative AI model.

8. One or more non-transitory computer-readable storage media configured to store instructions that, in response to being executed, cause a system to perform operations, the operations comprising:
obtaining a topic and an artificial intelligence (AI) role relating to the topic, the topic relating to a field of study and the AI role representing an occupational role in the field of study in which the topic and the AI role are specified by a human user;
generating, by a first generative AI model, a question prompt based on the topic and the AI role;
generating, by the first generative AI model, one or more statements as a statement set corresponding to the question prompt;
masking key terms included in the statements of the statement set to form sets of masked statements in which each statement of the statement set includes a respective key term and each masked statement included in a particular set includes at least one masked key term;
determining, by a second generative AI model, a set of unmasked statements in which a respective unmasked statement is based on a corresponding masked statement; and
evaluating performance of the second generative AI model based on comparing the sets of unmasked statements to respective statements included in the statement set.

9. The one or more non-transitory computer-readable storage media of claim 8, wherein the operations further comprise retraining or fine-tuning the second generative AI model using a second training dataset different from a first training dataset initially used to train the second generative AI model based on evaluation of the performance of the second generative AI model indicating that the second generative AI model provides inaccurate outcomes according to the comparing the sets of unmasked statements to respective statements included in the statement set.

10. The one or more non-transitory computer-readable storage media of claim 8, wherein one or more of the statements included in the statement set are provided by a human user and the one or more statements generated by the first generative AI model and provided by the human user are true statements or false statements about the question prompt.

11. The one or more non-transitory computer-readable storage media of claim 8, wherein masking the key terms included in the statements of the statement set to form the sets of masked statements includes:
identifying one or more stop words that represent common words involved in natural language processing of the statement set;
excluding the one or more stop words from each statement of the statement set;
identifying the key terms included in each respective statement based on words remaining in each statement after excluding the one or more stop words; and
masking one of the identified key terms.

12. The one or more non-transitory computer-readable storage media of claim 8, wherein evaluating the performance of the second generative AI model includes computing an evaluation score that is based on a probability that the second generative AI model returns a correct masked key term to replace a particular masked key term included in a particular statement and a total number of masked key terms included in the particular statement.

13. The one or more non-transitory computer-readable storage media of claim 8, wherein evaluating the performance of the second generative AI model includes computing an evaluation score that is based on a total number of masked key terms included in a particular statement and a ranking of how frequently a correct unmasked key term used to replace a particular masked term is returned by the second generative AI model relative to how frequently incorrect unmasked key terms used to replace the particular masked term are returned by the second generative AI model.

14. The one or more non-transitory computer-readable storage media of claim 8, wherein:
determining the set of unmasked statements is performed by the second generative AI model and a third generative AI model; and
evaluating the performance of the second generative AI model includes visually representing a fairness of the second generative AI model in comparison to a fairness of the third generative AI model.

15. A system, comprising:
one or more processors; and
one or more non-transitory computer-readable storage media configured to store instructions that, in response to being executed, cause the system to perform operations, the operations comprising:
obtaining a topic and an artificial intelligence (AI) role relating to the topic, the topic relating to a field of study and the AI role representing an occupational role in the field of study in which the topic and the AI role are specified by a human user;
generating, by a first generative AI model, a question prompt based on the topic and the AI role;
generating, by the first generative AI model, one or more statements as a statement set corresponding to the question prompt;
masking key terms included in the statements of the statement set to form sets of masked statements in which each statement of the statement set includes a respective key term and each masked statement included in a particular set includes at least one masked key term;
determining, by a second generative AI model, a set of unmasked statements in which a respective unmasked statement is based on a corresponding masked statement; and
evaluating performance of the second generative AI model based on comparing the sets of unmasked statements to respective statements included in the statement set.

16. The system of claim 15, wherein the operations further comprise retraining or fine-tuning the second generative AI model using a second training dataset different from a first training dataset initially used to train the second generative AI model based on evaluation of the performance of the second generative AI model indicating that the second generative AI model provides inaccurate outcomes according to the comparing the sets of unmasked statements to respective statements included in the statement set.

17. The system of claim 15, wherein one or more of the statements included in the statement set are provided by a human user and the one or more statements generated by the first generative AI model and provided by the human user are true statements or false statements about the question prompt.

18. The system of claim 15, wherein evaluating the performance of the second generative AI model includes computing an evaluation score that is based on a probability that the second generative AI model returns a correct masked key term to replace a particular masked key term included in a particular statement and a total number of masked key terms included in the particular statement.

19. The system of claim 15, wherein evaluating the performance of the second generative AI model includes computing an evaluation score that is based on a total number of masked key terms included in a particular statement and a ranking of how frequently a correct unmasked key term used to replace a particular masked term is returned by the second generative AI model relative to how frequently incorrect unmasked key terms used to replace the particular masked term are returned by the second generative AI model.

20. The system of claim 15, wherein:
determining the set of unmasked statements is performed by the second generative AI model and a third generative AI model; and
evaluating the performance of the second generative AI model includes visually representing a fairness of the second generative AI model in comparison to a fairness of the third generative AI model.
